(19) United States
(12) Patent Application Publication
(10) Pub. No.: US 2016/0195757 A1
(43) Pub. Date: Jul. 7, 2016

(54) LIQUID CRYSTAL DISPLAY WITH POLARIZERS OF DIFFERENT DIMENSIONS

(71) Applicant: Samsung Display Co., Ltd., Yongin-si (KR)

(72) Inventors: Tae Woo LIM, Yongin-si (KR); Pil Sook KWON, Incheon (KR); Yong Seok KIM, Seoul (KR)

(21) Appl. No.: 14/930,911

(22) Filed: Nov. 3, 2015

(30) Foreign Application Priority Data
Jan. 2, 2015 (KR) 10-2015-0000227

(51) Int. Cl. G02F 1/1333; G02F 1/1368; G02F 1/1335

(52) U.S. Cl. CPC G02F 1/133305; G02F 1/133528; G02F 1/1368; G02F 1/133377

(57) ABSTRACT

A liquid crystal display is presented. The display includes: a substrate having an upper surface and a lower surface; a lower polarizing plate positioned on the lower surface of the substrate; a thin film transistor positioned on the upper surface of the substrate; a pixel electrode connected to the thin film transistor; a roof layer covering a plurality of microcavities formed on the pixel electrode and including an organic material; a liquid crystal layer interposed in the microcavities; and a upper polarizing plate positioned on an upper surface of the liquid crystal layer, in which the lower polarizing plate has a thickness that is larger than a thickness of the upper polarizing plate.

### CROSS-REFERENCE TO RELATED APPLICATION

This application claims priority to and the benefit of Korean Patent Application No. 10-2015-0000227 filed in the Korean Intellectual Property Office on Jan. 2, 2015, the entire contents of which are incorporated herein by reference.

### BACKGROUND

(a) Field of the Invention

The present invention relates to a liquid crystal display.

(b) Description of the Related Art

A liquid crystal display is, currently, one of the most widely used flat panel displays. A liquid crystal display is formed of a panel including two display panels formed of field generating electrodes such as a pixel electrode and a common electrode, and a liquid crystal layer interposed therebetween.

A liquid crystal display displays an image by applying a voltage to a field generating electrode to generate an electric field on the liquid crystal layer, determining alignment of liquid crystal molecules of the liquid crystal layer therethrough, and controlling polarization of incident light.

As one of the uses of the liquid crystal display is as a display device or monitor of a television unit, its size has been increasing. As the size of the liquid crystal display increases, a difference in views between the case where a viewer sees the center of the monitor and the case where the viewer sees left and right ends of the monitor becomes more dramatic. A curved display device may be formed by curving the display device in a concave type or convex type in order to reduce the difference between views.

Recently, as one of the liquid crystal displays, a technology of implementing a display by forming a plurality of microcavities in a pixel and filling a liquid crystal therein has been developed. In an existing liquid crystal display, two substrates are used. With this microcavity technology, constituent elements may be formed on one substrate to reduce the weight, a thickness, and the like of a device.

When the substrate is curved, tensile force applied to the substrate is proportional to the distance from the central axis of the liquid crystal display, and in the case where the aforementioned technology is used, since the microcavities, and constituent elements such as a liquid crystal or a stiffener filled in the microcavities are laminated on an upper portion of the substrate, the substrate moves away from the central axis of the liquid crystal display to increase tensile force applied to the substrate. Therefore, research for minimizing maximum tensile stress applied to the substrate has been pursued.

The above information disclosed in this Background section is only for enhancement of understanding of the background of the invention and therefore it may contain information that does not form the prior art that is already known in this country to a person of ordinary skill in the art.

### SUMMARY

The present invention has been made in an effort to reduce tensile stress concentrated on a substrate in a curved liquid crystal display including a microcavity.

An exemplary embodiment of the present invention provides a liquid crystal display including: a substrate having an upper surface and a lower surface; a lower polarizing plate positioned on the lower surface of the substrate; a thin film transistor positioned on the upper surface of the substrate; a pixel electrode connected to the thin film transistor; a roof layer covering a plurality of microcavities formed on the pixel electrode and including an organic material; a liquid crystal layer interposed in the microcavities; and an upper polarizing plate positioned on an upper surface of the roof layer, in which the lower polarizing plate has a thickness that is larger than a thickness of the upper polarizing plate.

The lower polarizing plate may have the thickness that is 1.4 times to 10 times the thickness of the upper polarizing plate.

The substrate may be a flexible substrate formed of a glass substrate or a transparent plastic substrate.

The substrate may have a thickness of 50 to 250 um.

The liquid crystal display may further include an overcoat formed on an upper portion of the roof layer.

In the substrate, the upper surface may be a recess portion and the lower surface may be a convex portion.

A central axis of the liquid crystal display may be positioned in a lower portion of the substrate.

The liquid crystal display may further include a protection film attached to a lower surface of the lower polarizing plate and having a modulus that is larger than a modulus of the lower polarizing plate.

The modulus of the protection film may be 2 Gpa or more.

The upper polarizing plate may include a first polarizer polarizing incident light; and a first transparent support formed on at least one surface of an upper surface or a lower surface of the first polarizer, and the lower polarizing plate may include a second polarizer polarizing the incident light; and a second transparent support formed on at least one surface of an upper surface or a lower surface of the second polarizer.

The second transparent support may have a thickness that is 3 to 40 times a thickness of the first transparent support.

One or more of the first polarizer and the second polarizer may be formed of polyvinyl alcohol (PVA).

One or more of the first transparent support and the second transparent support may be formed of triacetyl cellulose (TAC).

According to the curved liquid crystal display, it is possible to reduce tensile stress applied to a substrate by adjusting a thickness ratio of polarizing plates positioned at upper and lower portions of the substrate.

### BRIEF DESCRIPTION OF THE DRAWINGS

FIG. 1 is a cross-sectional view of a liquid crystal display according to an exemplary embodiment of the inventive concept.

FIG. 2 is a perspective view of the liquid crystal display according to the exemplary embodiment of the inventive concept.

FIG. 3 is a cross-sectional view of the liquid crystal display according to the exemplary embodiment of the inventive concept.

FIG. 4 illustrates the same cross-section as FIG. 3 with respect to a liquid crystal display according to a comparative exemplary embodiment of the inventive concept.

FIG. 5 illustrates magnitude of tensile stress according to a distance from a central axis of the liquid crystal display.

FIG. 6 is a view illustrating a constitution of a polarizing plate of the liquid crystal display according to the exemplary embodiment of the inventive concept.

FIG. 7 is a graph illustrating an increase amount of tensile stress applied to a substrate according to a thickness ratio of an upper polarizing plate and a lower polarizing plate in the liquid crystal displays according to an exemplary embodiment and a comparative exemplary embodiment of the inventive concept.

FIG. 8 is a top plan view illustrating the liquid crystal display according to the exemplary embodiment of the inventive concept.

FIG. 9 is a cross-sectional view taken along cut line IV-IV of FIG. 8.

FIG. 10 is a cross-sectional view taken along cut line V-V of FIG. 8.

### DETAILED DESCRIPTION OF THE EMBODIMENTS

The present disclosure will be described more fully hereinafter with reference to the accompanying drawings, in which exemplary embodiments are shown. As those skilled in the art would realize, the described embodiments may be modified in various different ways, all without departing from the spirit or scope of the disclosure.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

Now, a display device according to an exemplary embodiment of the inventive concept will be schematically described below.

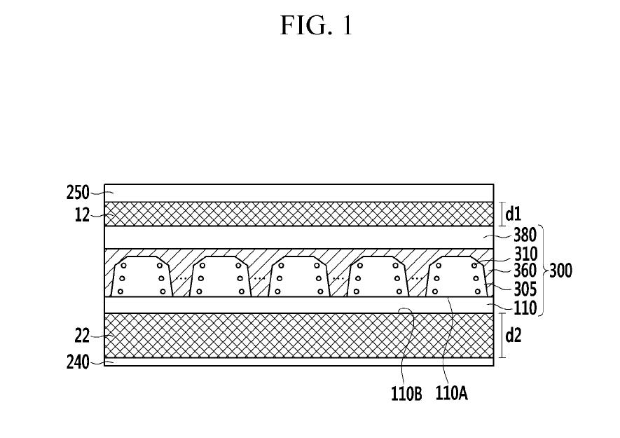

FIG. 1 is a cross-sectional view of a liquid crystal display according to the exemplary embodiment of the present invention. For convenience, in FIG. 1, only partial constituent elements are illustrated.

A liquid crystal display 10 includes a display region and a peripheral region surrounding the display region. In this case, the liquid crystal display 10 may have a quadrangular plate shape having a long axis, a short axis, and a predetermined thickness.

The display region is a region outputting an actual image, and in the peripheral region, a gate driver or a data driver is formed, or a gate pad portion (not illustrated) and a data pad portion (not illustrated) including a gate pad or a data pad that is a portion connected to an external circuit and the like are positioned. Generally, the gate pad is a wide portion positioned at an end of a gate line, and the data pad is a wide portion positioned at an end of a data line.

In the display region of the liquid crystal display 10 according to the exemplary embodiment of the present invention, there is the substrate 110, and a thin film transistor (not illustrated) for driving the liquid crystal display 10 and a thin film transistor array panel including wires are formed on an upper surface of the substrate 110.

In this case, the substrate 110 may be formed of glass or a transparent plastic material.

A plurality of microcavities 305 are disposed on the thin film transistor array panel. A liquid crystal material enters an empty space of the microcavity 305 to form a liquid crystal layer 310, and the microcavity is covered by a roof layer 360. This will be described in detail later.

Meanwhile, an overcoat 380 is formed on an upper portion of the roof layer 360. The overcoat 380 may be formed to cover an injection hole 307 through which a portion of the microcavity 305 is exposed to the outside. That is, the overcoat 380 may seal the microcavity 305 so that the liquid crystal material formed in the microcavity 305 is not discharged to the outside. In this case, since the overcoat 380 may come into contact with the liquid crystal material, it is preferable that the overcoat be formed of a material not reacted with the liquid crystal material, and for example, the overcoat 380 may be formed of parylene or the like.

The overcoat 380 may be formed of multiple layers such as a double layer or a triple layer. In this case, the double layer may be formed of two layers formed of different materials, and the triple layer may be formed of three layers and materials of adjacent layers that are formed to be different from each other. For example, the overcoat 380 may include a layer formed of an organic insulating material and a layer formed of an inorganic insulating material.

The overcoat 380 may be formed to cover all of the display region and the peripheral region, and a thickness thereof may be 10 um or more.

In the liquid crystal display 10 according to the present exemplary embodiment, polarizing plates 12 and 22 are formed in upper and lower portions thereof, respectively. The polarizing plate may be formed of an upper polarizing plate 12 and a lower polarizing plate 22. The upper polarizing plate 12 may be attached to an upper surface of the overcoat 380, and the lower polarizing plate 22 may be attached to a lower surface of the substrate 110.

In this case, according to the present exemplary embodiment, the lower polarizing plate 22 is formed to have a thickness that is larger than a thickness of the upper polarizing plate 12.

That is, in the liquid crystal display 10 according to the present exemplary embodiment, a position of a central axis N in a thickness (height) direction of the liquid crystal display 10 may be configured to be close to the lower surface of the substrate 110 by forming the lower polarizing plate 22 disposed in the lower portion of the liquid crystal display 10 in a thickness that is larger than the thickness of the upper polarizing plate 12 disposed in the upper portion.

In this case, in the present specification, the central axis N and N′ means an axis taken along a central line in a thickness (height) direction of the quadrangular plate-shaped liquid crystal display 10.

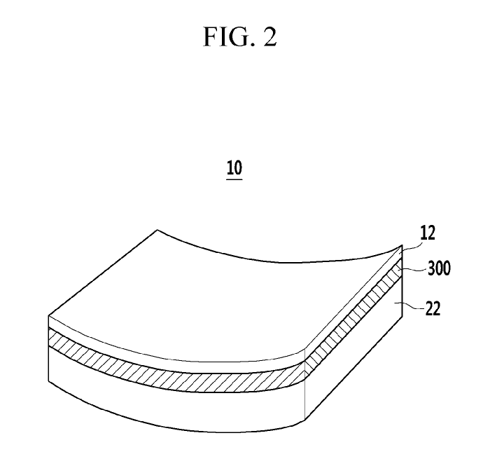

Hereinafter, the liquid crystal display 10 according to the exemplary embodiment and effects thereof will be described in detail with reference to a comparative exemplary embodiment. FIG. 2 is a perspective view of the liquid crystal display 10 according to the exemplary embodiment of the present invention.

Referring to FIG. 2, the liquid crystal display 10 according to the present exemplary embodiment may be bent as illustrated, to form a curved shape. In the case where the substrate 110 is formed of glass, the liquid crystal display 10 is maintained in the bent state. In the case where the substrate 110 is a flexible substrate formed of a plastic material such as polyethylene naphthalate (PEN), polycarbonate (PC), polyarylate (PAR), polyether imide (PEI), polyether sulfone (PES), and polyimide (PI), the liquid crystal display may be bent and straightened back.

The present exemplary embodiment depicts a liquid crystal display 10 in a landscape orientation where the liquid crystal display 10 is bent in the direction of a long side of a rectangular substrate 110. A “horizontal direction,” as used herein, is the direction along which the display is curved—in the particular example of FIG. 2, it would be the direction in which the long sides of the rectangular display extend. This is, however, not a limitation of the liquid crystal display, which may be bent in a portrait orientation or any other orientation.

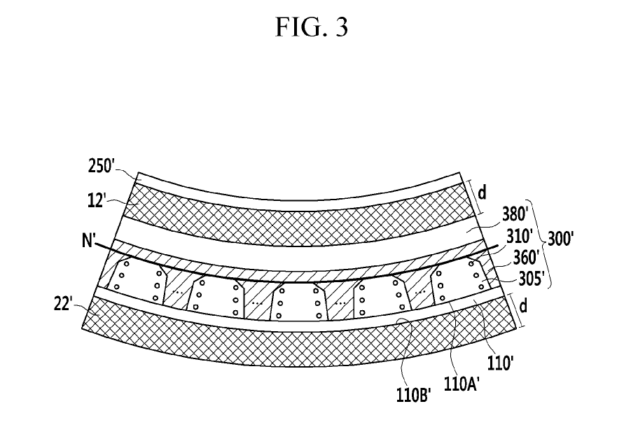

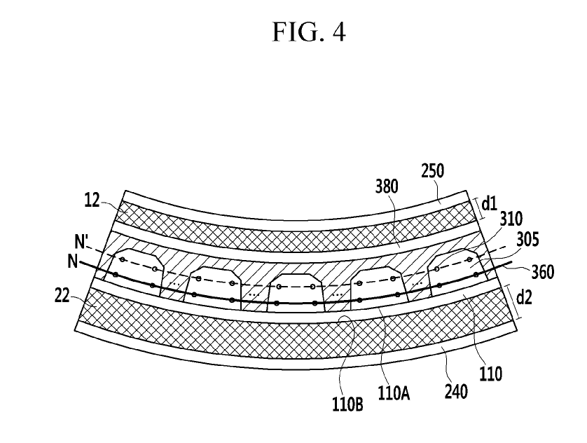

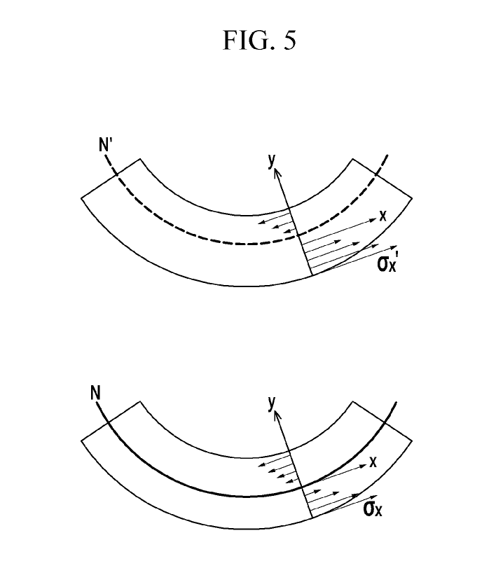

FIG. 3 is a cross-sectional view of the liquid crystal display according to the exemplary embodiment, FIG. 4 illustrates the same cross-section as FIG. 3 with respect to a liquid crystal display according to the comparative exemplary embodiment, and FIG. 5 illustrates magnitude of the tensile stress according to a distance from a central axis of the liquid crystal display.

The liquid crystal display 10 according to the present exemplary embodiment, as illustrated in FIG. 3, may be formed so that an upper surface is a recess portion and a lower surface is a convex portion. In this case, as an upper surface 110A of the substrate 110 is compressed by external force, it experiences compression stress resisting compression. A lower surface 110B of the substrate 110 is extended, and experiences tensile stress resisting extension occurs.

Magnitudes of compression stress and tensile stress occurring in the substrate 110, as illustrated in FIG. 5, are proportional to a distance from the central axis N of the liquid crystal display.

That is, as the distance from the central axis of the liquid crystal display increases, the magnitudes of compression stress and tensile stress applied to the substrate also increase. If the distance from the central axis of the liquid crystal display is small, the magnitudes of compression stress and tensile stress applied to the substrate are reduced.

Glass and transparent plastic materials mainly used in the substrate 110 are brittle materials that may break in response to even very little deformation. The brittle materials have a characteristic where the brittle materials are weak to tensile stress as compared to compression stress.

Accordingly, in the case where a distance between the central axis N of the liquid crystal display 10 and the lower surface 110B of the substrate 110 is increased due to the presence of elements such as the microcavity 305, the roof layer 360, and the overcoat 380 disposed on the upper portion of the substrate 110, damage such as cracks occur in the substrate 110 due to compression stress concentrated on the lower surface 110B of the substrate 110.

Therefore, in order to protect the liquid crystal display 10 from tensile stress occurring in the substrate 110, stress applied to the lower surface of the substrate 110 may be reduced by adjusting the thickness ratio of the polarizing plates 12 and 22 respectively disposed in the upper and lower portions of the substrate 110.

In the present exemplary embodiment, a thickness d2 of the lower polarizing plate may be 1.4 times to 10 times a thickness d1 of the upper polarizing plate.

In other words, the liquid crystal display 10 according to the present exemplary embodiment is formed so that the thickness d2 of the lower polarizing plate is larger than the thickness d1 of the upper polarizing plate to enable the position of the central axis N of the liquid crystal display 10 to be close to the substrate 110, and thus stress concentrated on the lower surface of the substrate 110 is reduced.

Further, according to the present exemplary embodiment, the liquid crystal display 10 may further include a protection film 240 attached to the lower surface of the lower polarizing plate 22. In this case, the protection film 240 may have a modulus that is larger than a modulus of the lower polarizing plate 22 in order to protect the lower polarizing plate 22 formed at the outermost portion of the central axis N of the liquid crystal display 10.

In the present exemplary embodiment, the protection film 240 may have the modulus of 2 Gpa or more, but this is not a limitation of the inventive concept.

FIG. 4 illustrates the same cross-section as FIG. 3 with respect to the liquid crystal display according to the comparative exemplary embodiment of the present disclosure. Referring to FIG. 4, in a liquid crystal display 10′ according to the comparative exemplary embodiment of the present inventive disclosure, thicknesses d of polarizing plates disposed on upper and lower portions of a substrate are the same as each other.

In the liquid crystal display 10′ according to the comparative exemplary embodiment, since structures such as a microcavity 305′, a roof layer 360′, and an overcoat 380′ are laminated on an upper surface of a substrate 110′ as illustrated in FIG. 4, an interval between a central axis N′ of the liquid crystal display 10′ and a lower surface of the substrate 110′ is increased.

Therefore, in the case where the thickness d of the upper polarizing plate is the same as the thickness d of the lower polarizing plate, the interval between the central axis N′ of the liquid crystal display 10′ and the lower surface of the substrate 110′ is increased, and thus stress is concentrated on the lower surface of the substrate 110′.

Accordingly, in the liquid crystal display 10′ according to the comparative exemplary embodiment, damage such as cracks occurs on the substrate 110′.

However, in the liquid crystal display 10 according to the exemplary embodiment as illustrated in FIG. 5, the thickness ratios of the polarizing plates disposed on the upper and lower portions of the substrate 110 are set differently to reduce the interval between the central axis and the lower surface of the substrate. Therefore, in the case where the liquid crystal display 10 is bent to be manufactured in a curved type, stress may be prevented from being concentrated on the lower portion of the substrate 110, thus reducing vulnerabilities such as a tendency to crack.

In this case, the thickness d2 of the lower polarizing plate is 1.4 to 10 times the thickness d1 of the upper polarizing plate. Accordingly, in the liquid crystal display 10 according to the present exemplary embodiment, the position of the central axis may be shifted from N′ to N to become close to the lower portion of the substrate 110 by ½ times a difference (d2−d1) between the thickness d2 of the lower polarizing plate and the thickness d1 of the upper polarizing plate.

Therefore, by setting the thickness d2 of the lower polarizing plate to be larger than the thickness d1 of the upper polarizing plate, the interval between the central axis N of the liquid crystal display 10 and the lower surface of the substrate 110 may be reduced, and thus the magnitude of tensile stress concentrated on the lower surface of the substrate 110 may be minimized.

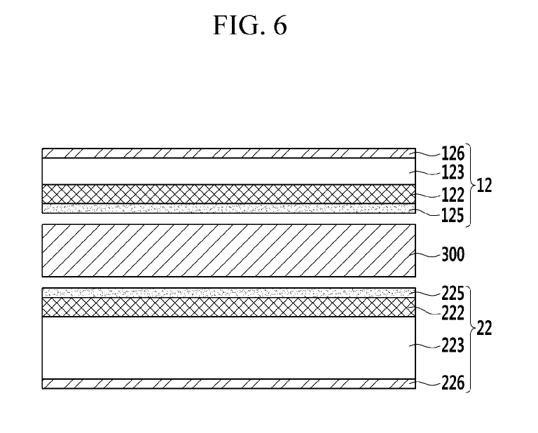

FIG. 6 illustrates a constitution of the polarizing plates 12 and 22 of the liquid crystal display 10 according to the exemplary embodiment of the present disclosure. Referring to FIG. 6, the liquid crystal display 10 according to the exemplary embodiment includes a panel portion 300, the upper polarizing plate 12 formed on an upper surface of the panel portion 300, and the lower polarizing plate 22 formed on a lower surface of the panel portion 300.

In the present disclosure, the “panel portion 300” is generically used to refer to a substrate 110 and the plurality of microcavities 305, the roof layer 360, the liquid crystal layer 310, and the overcoat 380 formed on the upper portion of the substrate 110. Detailed description of each constituent element will be omitted.

As illustrated in FIG. 6, the upper polarizing plate 12 according to the exemplary embodiment polarizes incident light, and includes a first polarizer 122 and a first transparent support 123.

The first polarizer 122 polarizes light that is incident on the upper polarizing plate 12. In this case, the first polarizer 122 is formed of polyvinyl alcohol (PVA). The first polarizer 122 may be formed by stretching polyvinyl alcohol that is a polymer material, adsorbing a pigment such as iodine thereon, and performing alignment. The upper polarizing plate 12 may include a polarization groove formed on an upper surface of the first polarizer 122.

The first transparent support 123 is attached to the upper surface or/and the lower surface of the first polarizer 122. The first transparent support 123 serves to reinforce strength of the entire upper polarizing plate 12 supporting the first polarizer 122 and, simultaneously, protect the polarization groove. The first transparent support 123 may be formed of triacetyl cellulose (TAC).

Meanwhile, the first polarizer 122 according to the exemplary embodiment is formed of PVA and the first transparent support 123 is formed of TAC, but the first polarizer 122 and the first transparent support 123 according to another exemplary embodiment may be formed of another material such as PET, PMMA, PC, and/or PEN.

Further, in the upper polarizing plate 12 according to another exemplary embodiment, a constitution selected from a protection layer 126, an adhesive 125, and a release film may be further attached to the first polarizer 122 and the first transparent support 123.

Meanwhile, the lower polarizing plate 22 according to the exemplary embodiment polarizes incident light, and includes a second polarizer 222 and a second transparent support 223.

The second polarizer 222 polarizes light that is incident on the lower polarizing plate 22. In this case, the second polarizer 222 is formed of polyvinyl alcohol (PVA). The second polarizer 222 may be formed by stretching polyvinyl alcohol that is a polymer material, adsorbing a pigment such as iodine thereon, and performing alignment. The lower polarizing plate 22 may include a polarization groove formed on an upper surface of the second polarizer 110.

The second transparent support 223 is attached to the upper surface or/and the lower surface of the second polarizer 222. The second transparent support 223 serves to reinforce strength of the entire lower polarizing plate 22 supporting the second polarizer 222 and, simultaneously, protect the polarization groove. The second transparent support 223 may be formed of triacetyl cellulose (TAC).

A thickness of the second transparent support 223 may be 3 to 40 times a thickness of the first transparent support 123.

That is, in the liquid crystal display 10 according to the present exemplary embodiment, by forming the second transparent support 223 in a large thickness while a thickness of the polarizer 222 disposed on the lower portion of the panel portion 300 is not changed, the thickness of the lower polarizing plate 22 may be larger than the thickness of the upper polarizing plate 12. Therefore, even though a polarization condition is not changed, the thickness of the lower polarizing plate 22 may be large.

Meanwhile, the second polarizer 222 according to the exemplary embodiment is formed of PVA and the second transparent support 223 is formed of TAC, but the second polarizer 222 and the second transparent support 223 according to another exemplary embodiment may be formed of another material such as PET, PMMA, PC, and/or PEN.

Further, in the upper polarizing plate 22 according to another exemplary embodiment, a constitution selected from a protection layer 226, an adhesive 225, and a release film may be further attached to the second polarizer 222 and the second transparent support 223.

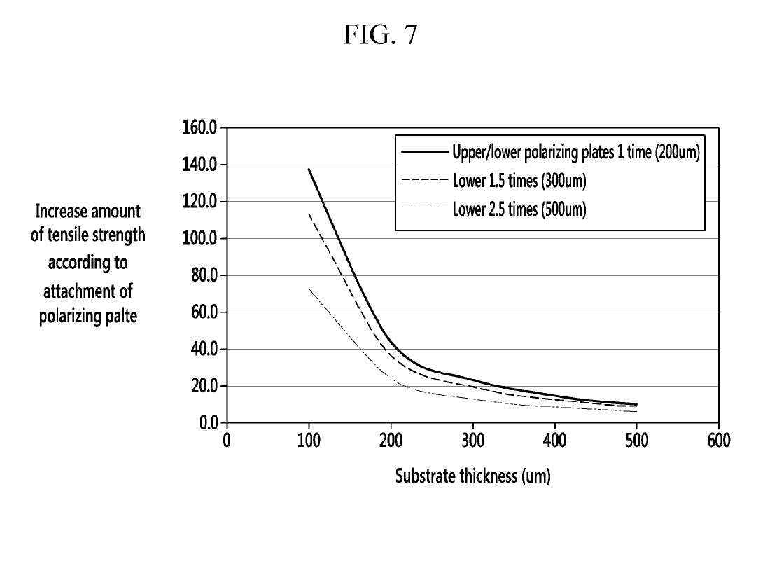

FIG. 7 is a graph illustrating the amount of tensile stress applied to the substrate according to the thickness ratio of the upper polarizing plate and the lower polarizing plate in the liquid crystal displays according to the exemplary embodiment and the comparative exemplary embodiment of the present disclosure.

Referring to FIG. 7, the increase in amount of tensile stress applied to the substrate of the liquid crystal display according to the comparative exemplary embodiment of the present invention is 10% to 138%, depending on the substrate thickness.

This is caused by, as described above, the distance formed between the central axis of the liquid crystal display and the substrate because the central axis of the liquid crystal display is formed at the upper portion of the substrate by the structure positioned on the upper surface of the substrate but there is no difference in thickness of the polarizing plates of the upper and lower portions.

Therefore, tensile stress concentrated on the substrate is increased by the distance between the central axis of the liquid crystal display and the substrate. If tensile stress concentrated on the substrate gets high enough, cracks occur in the substrate, which is usually made of a brittle material that is weak to tensile stress.

However, in the liquid crystal display according to the exemplary embodiment of the present invention, by forming the lower polarizing plate in a thickness that is larger than the thickness of the upper polarizing plate, the distance between the central axis of the liquid crystal display and the substrate is reduced.

That is, in the liquid crystal display according to the present exemplary embodiment, the central axis is biasedly formed at the upper portion of the substrate by the structure positioned on the upper surface of the substrate, but by forming the lower polarizing plate in the thickness that is larger than the thickness of the upper polarizing plate, the distance formed between the central axis of the liquid crystal display and the substrate may be reduced.

Accordingly, it can be seen that the increase in the amount of tensile stress applied to the substrate is 7% to 72% and is improved by a difference of 3% to 66% as compared to the increase amount of tensile stress applied to the substrate according to the comparative exemplary embodiment.

Particularly, this improvement effect is more clearly exhibited as the thickness of the substrate is reduced, and thus in the liquid crystal display according to another exemplary embodiment, the thickness of the substrate may be 50 um to 250 um.

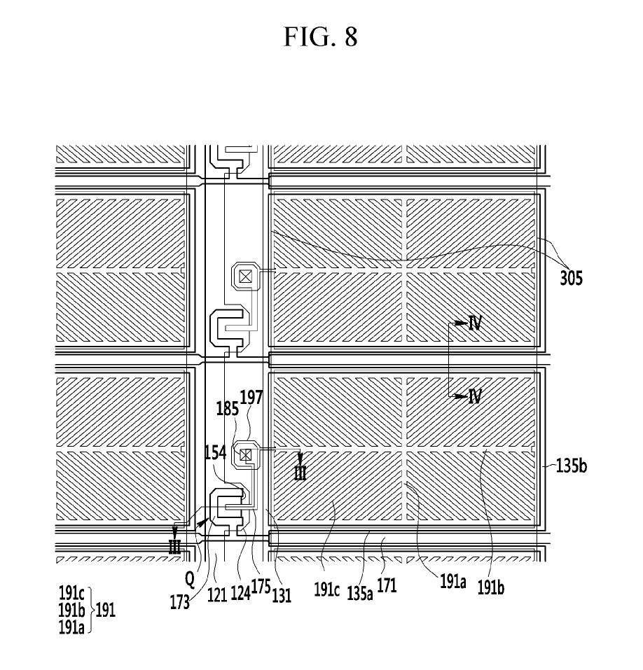

Then, a structure of the liquid crystal display according to the exemplary embodiment will be described in detail with reference to FIGS. 8 to 10.

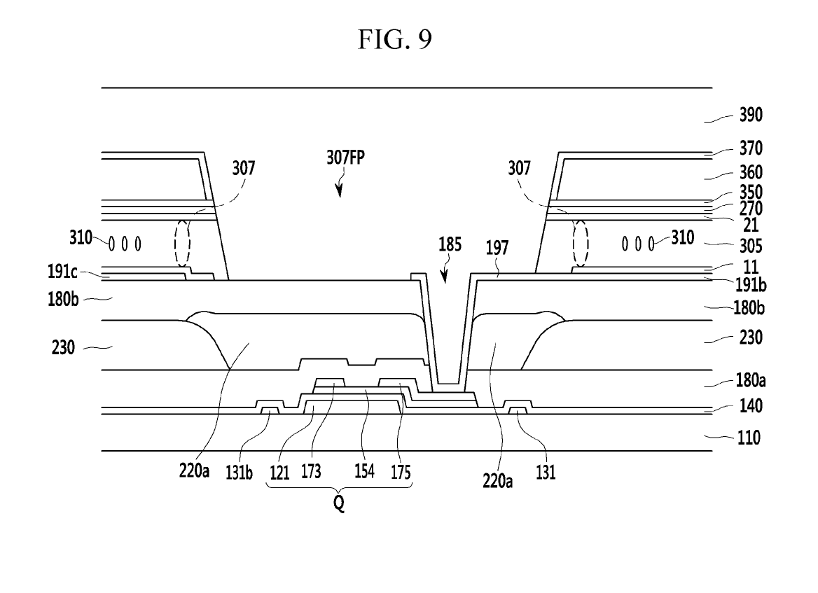

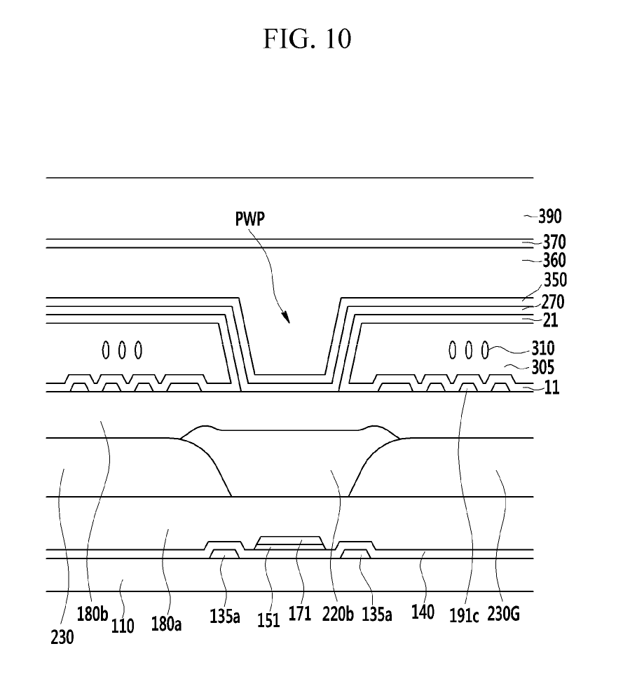

FIG. 8 is a top plan view illustrating the liquid crystal display 10 according to the exemplary embodiment of the present disclosure. FIG. 9 is a cross-sectional view taken along cut line IV-IV of FIG. 8. FIG. 10 is a cross-sectional view taken along cut line V-V of FIG. 8.

Referring to FIGS. 8 to 10, a gate line 121 and a storage electrode line 131 are disposed on the substrate 110 made of transparent glass, plastic, or the like.

The gate line 121 mainly extends in a vertical direction, and transfers a gate signal. The gate line 121 includes a gate electrode 124 protruding in a horizontal direction.

The storage electrode line 131 mainly extends in a horizontal direction and transfers a predetermined voltage such as a common voltage Vcom. The storage electrode line 131 includes a pair of horizontal portions 135a extending to be substantially vertical to the gate line 121, and a vertical portion 135b connecting ends of the pair of horizontal portions 135a to each other. The horizontal portion and vertical portion 135a and 135b of the storage electrode line 131 has a structure surrounding a pixel electrode 191 as will be described later.

A gate insulating layer 140 is disposed on the gate line 121 and the storage electrode line 131.

A semiconductor layer 151 is disposed on the gate insulating layer 140. The semiconductor layer 151 includes a protrusion portion 154 overlapping the gate electrode 124.

A data line 171 including a source electrode 173 and a drain electrode 175 are disposed on the semiconductor layer 151.

The data line 171 transfers a data signal, mainly extends in a horizontal direction, and crosses the gate line 121 and the storage electrode line 131. The source electrode 173 protrudes toward the gate electrode 124, and is disposed on the protrusion portion 154 of the semiconductor layer 151. The drain electrode 175 is separated from the data line 171, and is disposed on the protrusion portion 154 of the semiconductor layer 151. The drain electrode 175 faces the source electrode 173 based on the gate electrode 124.

The gate electrode 124, the source electrode 173, and the drain electrode 175 form one thin film transistor Q together with the protrusion portion 154 of the semiconductor layer 151, and a channel of the thin film transistor Q is formed at the protrusion portion 154 of the semiconductor layer 151 between the source electrode 173 and the drain electrode 175.

Between the semiconductor layer 151 and the data line 171, and between the protrusion portion 154 of the semiconductor layer 151 and the source electrode 173 and the drain electrode 175, ohmic contacts serving to reduce contact resistance therebetween may be disposed.

A first interlayer insulating layer 180a is disposed on the data line 171, the drain electrode 175, the protrusion portion 154 of the semiconductor layer 151 between the source electrode 173 and the drain electrode 175, and the gate insulating layer 140. The first interlayer insulating layer 180a may include an inorganic insulator such as silicon nitride (SiNx) and silicon oxide (SiOx) or an organic insulator.

A color filter 230, a vertical light blocking member 220a, and a horizontal light blocking member 220b are disposed on the first interlayer insulating layer 180a.

The vertical light blocking member 220a is disposed in a direction that is parallel to the gate line 121, and the horizontal light blocking member 220b is disposed in a direction that is parallel to the data line 171. The vertical light blocking member 220a and the horizontal light blocking member 220b are connected to each other to form a lattice structure having an opening corresponding to a region displaying an image, and include a material that does not transmit light.

The color filter 230 is disposed in the opening by the vertical light blocking member 220a and the horizontal light blocking member 220b, and may display one of primary colors such as three primary colors of red, green, and blue. However, the color is not limited to the three primary colors of red, green and blue colors, and one of cyan, magenta, yellow, and white-based colors may be displayed. The color filter 230 may include a material displaying the same color for each of pixels adjacent in a horizontal direction, and may include a material displaying different colors for each of pixels adjacent in a vertical direction.

A second interlayer insulating layer 180b is disposed on the color filter 230, the vertical light blocking member 220a, and the horizontal light blocking member 220b. The second interlayer insulating layer 180b may include an inorganic insulator such as silicon nitride (SiNx) and silicon oxide (SiOx) or an organic insulator. Unlike a matter illustrated in the cross-sectional view of FIG. 4, in the case where a step occurs due to a difference in thickness of the color filter 230 and the vertical light blocking member 220a, the second interlayer insulating layer 180b may include the organic insulator to reduce or remove the step.

A contact hole 185, through which a portion of the drain electrode 175 is exposed, is formed in the vertical light blocking member 220a, and the first and second interlayer insulating layers 180a and 180b.

The pixel electrode 191 connected through the contact hole 185 to the drain electrode 175 is disposed on the second interlayer insulating layer 180b. The pixel electrode 191 may be made of a transparent conductive material such as ITO or IZO.

A whole shape of the pixel electrode 191 is a quadrangle, and the pixel electrode 191 includes a cross-shaped stem portion formed of a vertical stem portion 191a and a horizontal stem portion 191b crossing the vertical stem portion 191a. Further, the pixel electrode 191 is divided into four sub-regions by the vertical stem portion 191a and the horizontal stem portion 191b, and each sub-region includes a plurality of fine branch portions 191c. Further, in the present exemplary embodiment, an outskirt stem portion surrounding an outskirt of the pixel electrode 191 may be further included.

The fine branch portion 191c of the pixel electrode 191 forms an angle of about 40° to 45° with the gate line 121 or the vertical stem portion 191a. Further, the fine branch portions 191c of the two adjacent sub-regions may be orthogonal to each other. Further, the width of the fine branch portion 191c may be gradually increased or intervals between the fine branch portions 191c may be different from each other.

The pixel electrode 191 includes an extension portion 197 connected at a lower end of the horizontal stem portion 191b and having an area that is wider than the horizontal stem portion 191b, is physically and electrically connected through the contact hole 185 to the drain electrode 175 at the extension portion 197, and receives a data voltage from the drain electrode 175.

The description relating to the thin film transistor Q and the pixel electrode 191 is an example, and a thin film transistor structure and a pixel electrode design may be modified in order to improve lateral surface visibility.

A lower alignment layer 11 is disposed on the pixel electrode 191, an upper alignment layer 21 is disposed at a portion facing the lower alignment layer 11, and the microcavity 305 is disposed between the lower alignment layer 11 and the upper alignment layer 21.

The lower alignment layer 11 and the upper alignment layer 21 may be a vertical alignment layer. The lower alignment layer 11 and the upper alignment layer 21 may include at least one of materials generally used as a liquid crystal alignment layer, such as polyamic acid, polysiloxane, or polyimide.

A liquid crystal material forming the liquid crystal layer 310 is injected into the microcavity 305, and the microcavity 305 has a liquid crystal injection hole 307. The microcavity 305 may be disposed in a vertical direction. In the present exemplary embodiment, the alignment material forming the lower and upper alignment layers 11 and 21 and the liquid crystal material forming the liquid crystal layer 310 may be injected into the microcavity 305 by using capillary force.

The microcavity 305 is divided in a horizontal direction by a plurality of liquid crystal injection hole forming regions 307FP positioned at an overlapping portion with the gate line 121, and is formed in plural in an extension direction of the gate line 121. Each of the microcavities 305 formed in plural may correspond to one pixel, and the pixel may correspond to a region displaying a screen.

A common electrode 270 and a lower insulating layer 350 are disposed on the upper alignment layer 21. The common electrode 270 receives a common voltage and forms an electric field together with the pixel electrode 191 to which a data voltage is applied to determine an inclination direction of the liquid crystal layer 310 positioned in the microcavity 305 between the two electrodes. The common electrode 270 and the pixel electrode 191 form a capacitor to maintain the applied voltage even after the thin film transistor is turned off. The lower insulating layer 350 includes silicon nitride (SiNx) or silicon oxide (SiO₂).

Formation of the common electrode 270 on the microcavity 305 is described in the present exemplary embodiment, but the common electrode 270 can be formed in a lower portion of the microcavity 305 to drive liquid crystal according to a coplanar electrode mode as another exemplary embodiment.

The roof layer 360 is disposed on the lower insulating layer 350. The roof layer 360 serves to support the microcavity 305 so that the microcavity 305 that is a space between the pixel electrode 191 and the common electrode 270 is formed. The roof layer 360 may include a photoresist, or other organic materials.

An upper insulating layer 370 is disposed on the roof layer 360. The upper insulating layer 370 may come into contact with an upper surface of the roof layer 360. The upper insulating layer 370 includes silicon nitride (SiNx) or silicon oxide (SiO₂).

A capping layer 390 is disposed on the upper insulating layer 370 and in the liquid crystal injection hole forming region 307FP. The capping layer 390 fills the liquid crystal injection hole forming region 307FP and covers the liquid crystal injection hole 307 of the microcavity 305 exposed by the liquid crystal injection hole forming region 307FP. The capping layer 390 includes an organic material or an inorganic material.

Meanwhile, as illustrated in FIG. 10, a partition wall forming portion PWP is disposed between the microcavities 305 adjacent in a vertical direction. The partition wall forming portion PWP may be formed in an extension direction of the data line 171, and may be covered by the roof layer 360. The lower insulating layer 350, the common electrode 270, the upper insulating layer 370, and the roof layer 360 are filled in the partition wall forming portion PWP, and this structure may form a partition wall to section or define the microcavity 305.

While this inventive concept has been described in connection with what is presently considered to be practical exemplary embodiments, it is to be understood that the inventive concept is not limited to the disclosed embodiments, but, on the contrary, is intended to cover various modifications and equivalent arrangements included within the spirit and scope of the appended claims and the above description.

<Description of symbols>

| | |
|---|---|
| 12: Upper polarizing plate | 22: Lower polarizing plate |
| 110: Substrate | 121, 221: Adhesive |
| 122: First polarizer | 222: Second polarizer |
| 123: First transparent support | 223: Second transparent |
| | support |
| 124, 224: Protection layer | 300: Panel portion |
| 305: Microcavity | 310: Liquid crystal material |
| 360: Roof layer | 390: Overcoat |

What is claimed is:

1. A liquid crystal display comprising:
a substrate having an upper surface and a lower surface;
a lower polarizing plate positioned on the lower surface of the substrate;
a thin film transistor positioned on the upper surface of the substrate;
a pixel electrode connected to the thin film transistor;
a roof layer covering a plurality of microcavities formed on the pixel electrode and including an organic material;
a liquid crystal layer interposed in the microcavities; and
a upper polarizing plate positioned on an upper surface of the roof layer,
wherein the lower polarizing plate has a thickness that is larger than a thickness of the upper polarizing plate.

2. The liquid crystal display of claim 1, wherein:
the lower polarizing plate has the thickness that is 1.4 times to 10 times the thickness of the upper polarizing plate.

3. The liquid crystal display of claim 1, wherein:
the substrate is a flexible substrate formed of a glass substrate or a transparent plastic substrate.

4. The liquid crystal display of claim 1, wherein:
the substrate has a thickness of 50 to 250 um.

5. The liquid crystal display of claim 1, further comprising:
an overcoat formed on an upper portion of the roof layer.

6. The liquid crystal display of claim 3, wherein:
in the liquid crystal display, an upper surface is a concave surface and a lower surface is a convex surface.

7. The liquid crystal display of claim 1, further comprising:
a protection film attached to a lower surface of the lower polarizing plate and having a modulus that is larger than a modulus of the lower polarizing plate.

8. The liquid crystal display of claim 7, wherein:
the modulus of the protection film is 2 Gpa or more.

9. The liquid crystal display of claim 1, wherein:
the upper polarizing plate includes
a first polarizer polarizing incident light; and
a first transparent support formed on at least one surface of an upper surface or a lower surface of the first polarizer, and
the lower polarizing plate includes
a second polarizer polarizing the incident light; and
a second transparent support formed on at least one surface of an upper surface or a lower surface of the second polarizer.

10. The liquid crystal display of claim 9, wherein:
the second transparent support has a thickness that is 3 to 40 times a thickness of the first transparent support.

11. The liquid crystal display of claim 9, wherein:
one or more of the first polarizer and the second polarizer are formed of polyvinyl alcohol (PVA).

12. The liquid crystal display of claim 9, wherein:
one or more of the first transparent support and the second transparent support are formed of triacetyl cellulose (TAC).

13. The liquid crystal display of claim 6, wherein:
a central axis of the liquid crystal display is positioned in a lower portion of the substrate.
